(19) United States
(12) Patent Application Publication
(10) Pub. No.: US 2021/0033105 A1
(43) Pub. Date: Feb. 4, 2021

(54) FAN

(71) Applicant: SANDEN AUTOMOTIVE CLIMATE SYSTEMS CORPORATION, Isesaki-shi, Gunma (JP)

(72) Inventor: Masatoshi KAWASAKI, Isesaki-shi, Gunma (JP)

(21) Appl. No.: 16/967,358

(22) PCT Filed: Feb. 15, 2019
(86) PCT No.: PCT/JP2019/005634

§ 371 Date: Aug. 4, 2020

(30) Foreign Application Priority Data
Feb. 28, 2018 (JP) 2018-034824
Oct. 9, 2018 (JP) 2018-190787

(51) Int. Cl. F04D 29/42; F04D 17/10

(52) U.S. Cl. CPC F04D 29/4226; F05D 2240/12; F04D 17/10

(57) ABSTRACT

A fan includes a cylindrical impeller, and a casing including a first side plate, a second side plate and an outer plate. In each of the first side plate and the second side plate, parts respectively corresponding to starting end and terminal end sides of the spiral ventilation passage, and a section corresponding to a connecting ventilation passage extending from a terminal end portion of the spiral ventilation passage in a rotating direction of the impeller and connected to a starting end portion of the spiral ventilation passage form a smooth surface by: connecting flat planes having a certain height; connecting inclined planes having a height gradually changed; or connecting a flat plane and an inclined plane; and a dimension of the spiral ventilation passage in the rotation axis direction of the impeller gradually decreases from the starting end portion and the terminal end portion to a predetermined position.

### TECHNICAL FIELD

The present invention relates to a fan used in, for example, a vehicle air conditioner.

### BACKGROUND ART

Conventionally, there has been known a fan including a cylindrical impeller, and a casing with a spiral ventilation passage formed radially outside the impeller (see, for example, Patent Literature 1).

The casing includes a first side plate provided on one end side of the axial direction of the impeller; a second side plate provided on the other end side of the axial direction of the impeller, and including an air suction port; and an outer plate provided radially outside the impeller. The spiral ventilation passage is formed between the first side plate and the second side plate, and also between the outer periphery of the impeller and the outer plate.

The cross-sectional area of the flow path of the spiral ventilation passage is gradually increased from the starting end side toward the terminal end side to decrease the flow velocity of the flowing air to discharge the air from a discharge opening.

For the above-described fan, in order to gradually increase the cross-sectional area of the flow path of the spiral ventilation passage, the distance between the rotation axis of the impeller and the outer plate is gradually increased from the starting end side toward the terminal end side of the spiral ventilation passage while the dimension of the first side plate is gradually increased on one side of the rotation axis direction of the impeller. As a result, in the fan, the first side plate of the casing has a difference in level between the starting end side and the terminal end side of the spiral ventilation passage.

### CITATION LIST

### Patent Literature

PTL1: Japanese Patent Application Laid-Open No. H05-195995

### SUMMARY OF INVENTION

### Technical Problem

The above-described fan generates the circulating flow of the air flowing through the spiral ventilation passage from the terminal end side into the starting end side again. With the fan, in the case where the circulating air flows from the terminal end side into the starting end side of the spiral ventilation passage, when the air flowing along the first side plate collides with the part having the difference in level, the air flow separates from the first side plate, and therefore the turbulence of the air flow occurs in the starting end side of the spiral ventilation passage. The turbulence of the air flow in the starting end side of the spiral ventilation passage may cause the noise from the fan.

It is therefore an object of the present invention to provide a fan capable of preventing the turbulence of the circulating air flowing from the terminal end side to the starting end side of the spiral ventilation passage to improve the silence.

### Solution to Problem

To achieve the object, an aspect of the present invention provides a fan including: a cylindrical impeller; and a casing configured to accommodate the impeller, and including a spiral ventilation passage formed radially outside the impeller. The casing includes: a first side plate provided on a first end side of a rotation axis direction of the impeller; a second side plate provided on a second end side of the rotation axis direction of the impeller, and including an air suction port; and an outer plate provided radially outside the impeller. In each of the first side plate and the second side plate, parts respectively corresponding to a starting end side and a terminal end side of the spiral ventilation passage, and a section corresponding to a connecting ventilation passage which extends from a terminal end portion of the spiral ventilation passage in a rotating direction of the impeller and is connected to a starting end portion of the spiral ventilation passage form a smooth surface by at least one of: connecting flat planes having a certain height; connecting inclined planes having a height gradually changed; or connecting a flat plane and an inclined plane; and a dimension of the spiral ventilation passage in the rotation axis direction of the impeller gradually decreases from the starting end portion and the terminal end portion of the spiral ventilation passage to a predetermined position between the starting end portion and the terminal end portion of the spiral ventilation passage.

By this means, the parts of each of first side plate and the first side plate corresponding to the starting end side and the terminal end side of the spiral ventilation passage, and the part corresponding to the connecting ventilation passage are coplanar with each other. Therefore, the circulating flow flowing along the first side plate and the second side plate from the terminal end side into the starting end side of the spiral ventilation passage via the connecting ventilation passage does not separate from the first side plate and the second side plate. In addition, the circulating flow having flowed along the first side plate and the second side plate and into the starting end side of the spiral ventilation passage flows along the first side plate and the second plate, and therefore is conditioned.

According to the present invention, the circulating air having flowed along the first side plate and the second side plate and entered from the terminal end side into the starting end side of the spiral ventilation passage via the connecting ventilation passage can be flowed along the first side plate and the second side plate without separating the circulating air from the first side plate and the second side plate. In this way, the circulating air having flowed along the first side plate and the second side plate and entered the starting end side of the spiral ventilation passage can be flowed along the first side plate and the second side plate, and therefore it is possible to condition the air flow. As a result, it is possible to prevent noise from being generated to improve the silence.

### BRIEF DESCRIPTION OF DRAWINGS

FIG. 1 is an overall perspective view illustrating a fan according to an embodiment of the invention;

FIG. 2 is a plan view illustrating the fan;

FIG. 3 is a plane cross-sectional view illustrating the fan; and

FIG. 4 is a cross-sectional view illustrating the fan of FIG. 2 taken along line A-A.

### DESCRIPTION OF EMBODIMENTS

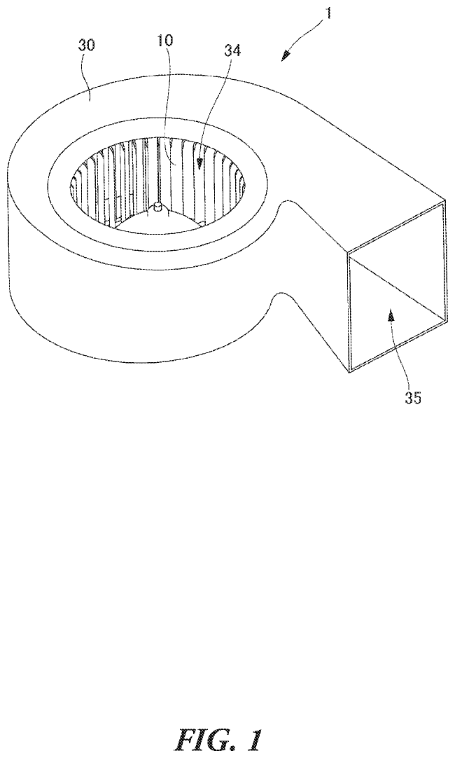

FIGS. 1 to 4 illustrate an embodiment of the invention.

As illustrated in FIG. 1, a fan 1 according to the invention is a centrifugal fan, and is used as a fan device, for example, in a vehicle air conditioner.

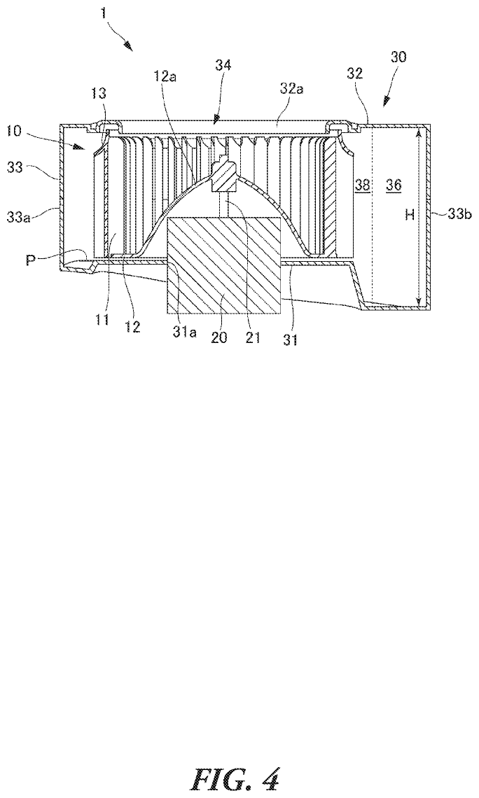

As illustrated in FIG. 4, the fan 1 includes a cylindrical impeller 10, an electric motor 20 configured to rotate the impeller 10, and a casing 30 configured to accommodate the impeller 10.

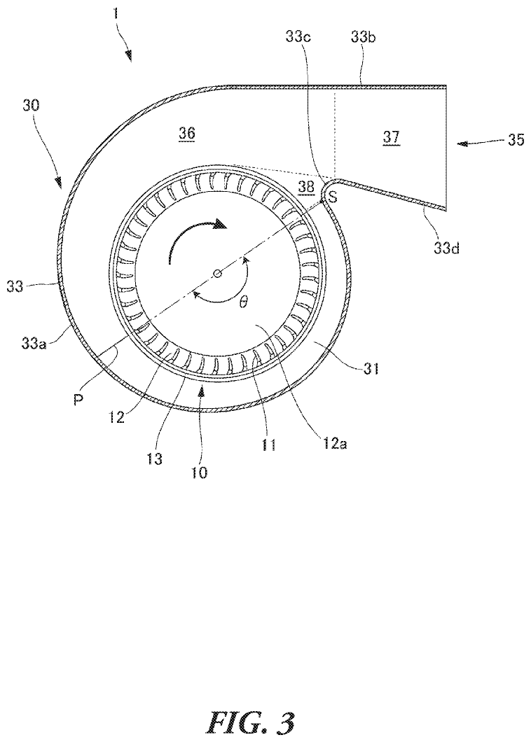

As illustrated in FIGS. 3 and 4, the impeller 10 includes a plurality of wings 11 which are spaced from each other at a predetermined interval in the circumferential direction, and each of which extends in the axial direction of the cylindrical shape, a substrate 12 provided on one end side (hereinafter “first end side”) of the axial direction, and a rim 13 provided on the other end side (hereinafter “second end side”) of the axial direction.

Each of the plurality of wings 11 is arranged so as to extend from the radially inner side toward the outer side. The outer end of each of the plurality of wings 11 is inclined with respect to the inner end in the radial direction, and the outer end bends toward a circumferential direction.

The substrate 12 is a disk-shaped member, and the outer ends of the wings 11 spaced from each other in the circumferential direction are coupled to the outer periphery of the substrate 12. The substrate 12 includes a swelling portion 12a which gradually swells toward the second end of the axial direction from the inside of the outer periphery to which the one end of each of the wings 11 is coupled to the center of the substrate 12. A concave portion is formed in one end of the axial direction of the swelling portion 12a, which gradually caves toward the second end side of the axial direction from the outer periphery to the center of the swelling portion 12a.

A rim 13 is a cylindrical member to which the other end portions of the wings 11 are connected to each other at intervals in the circumferential direction.

When the impeller 10 is rotated in one circumferential direction as indicated by the arrow in FIG. 3, about the center of the radial direction as the rotation axis, the air flows into the impeller 10 from the second end side of the rotation axis direction, and is radially flowed out of the gap between each of the wings 11 toward the outside of the radial direction.

As illustrated in FIG. 4, the electric motor 20 is disposed on the first end of the axial direction of the impeller 10, and in the concave portion formed in the one end of the rotation axis direction of the substrate 12. A rotating shaft 21 of the electric motor 20 is connected to the center of the substrate 12 in the radial direction. The electric motor 20 is configured to rotate the impeller 10 in one circumferential direction.

As illustrated in FIG. 4, the casing 30 includes a first side plate 31 provided on the first end side of the axial direction of the impeller 10, a second side plate 32 provided on the second end side of the rotation axial direction of the impeller 10, and an outer plate 33 extending between the outer peripheries of the first side plate 31 and the second side plate 32 in the circumferential direction of the impeller 10.

A motor support hole 31a is formed in approximately the center of the first side plate 31 to support the electric motor 20 penetrating the motor support hole 31a.

A suction port 34 is provided in approximately the center of the second side plate 32 to allow the air to be sucked into the casing 30. In addition, a cover 32a is provided on the edge of the suction port 34 of the second side plate 32 to cover the inside and the outside of the rim 13 of the impeller 10 in the radial direction, on the second end side of the rotation axis direction of the rim 13 of the impeller 10.

As illustrated in FIG. 3, the outer plate 33 includes a spiral portion 33a having a distance from the rotation axis of the impeller 10, which gradually increases from a predetermined reference position S apart from the rotation axis of the impeller 10 toward the rotating direction of the impeller 10, a straight portion 33b linearly extending from the outside end of the spiral portion 33a in the radial direction, a tongue portion 33c bending with a predetermined radius of curvature and extending in the direction opposite to the spiral portion 33a from the inside end of the spiral portion 33a in the radial direction, and an extension portion 33d extending continuously from the tongue portion 33c and spaced from the straight portion 33b.

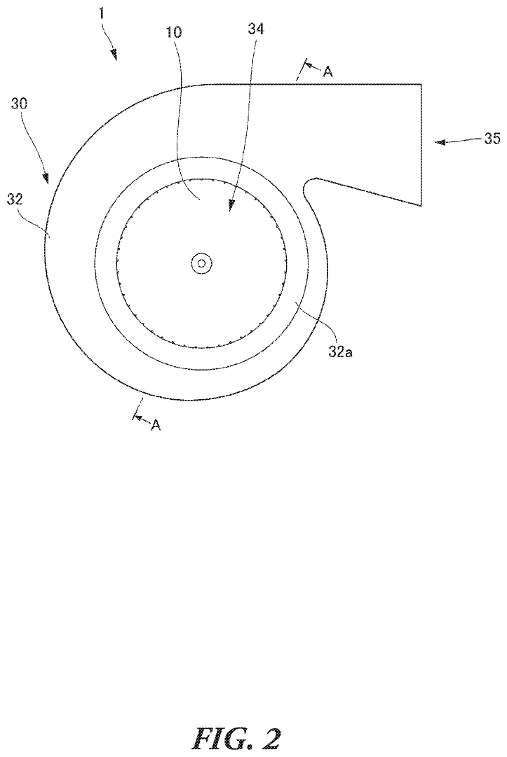

In addition, as illustrated in FIGS. 1 and 2, the casing 30 includes a discharge opening 35 configured to discharge the air sucked in the casing 30 via the suction port 34. As illustrated in FIGS. 3 and 4, the discharge opening 35 is formed at the end of the portion surrounded by the first side plate 31, the second side plate 32, the straight portion 33b and the extension portion 33d.

As illustrated in FIG. 3, the casing 30 includes the spiral ventilation passage 36 configured to circulate the air flowing into the casing 30 along the outer periphery of the impeller 10 in the rotating direction of the impeller 10, a discharge ventilation passage 37 configured to allow the communication between the terminal end portion of the spiral ventilation passage 36 and the discharge opening 35, and a connecting ventilation passage 38 which extends from the terminal end portion of the spiral ventilation passage 36 in the rotating direction of the impeller 10 and is connected to the starting end portion of the spiral ventilation passage 36.

The spiral ventilation passage 36 is provided between the first side plate 31 and the second side plate 32, and also between the outer periphery of the impeller 10 and part of the outer plate 33 including the spiral portion 33a and part of the straight portion 33b on the spiral portion 33a side. As illustrated in FIG. 3, the dimension of the spiral ventilation passage 36 gradually increases in the radial direction from the starting end portion toward the terminal end portion.

Moreover, a dimension H of the spiral ventilation passage 36 in the axial direction of the impeller 10 is changed between the starting end portion and the terminal end portion. That is, the dimension H of the spiral ventilation passage 36 in the rotation axial direction of the impeller 10 gradually decreases from the starting end side and the terminal end side to the predetermined position P between the starting end portion and the terminal end portion. The predetermined position P between the starting end portion and the terminal end portion of the spiral ventilation passage 36 is located at a predetermined angle θ about the rotation axis of the impeller 10, from the positon S of the inside end of the spiral portion 33a in the radial direction toward the rotating direction of the impeller 10. It is preferred that the predetermined angle θ is approximately 180 degrees.

To be more specific, the spiral ventilation passage 36 is formed between the second side plate 32 in a flat shape and the first side plate 31 having a shape where a distance from the second side plate 32 is gradually changed. The part of the first side plate 31 corresponding to the starting end portion of the spiral ventilation passage 36 is on approximately the same level as the part of first side plate 31 corresponding to the terminal end portion of the spiral ventilation passage 36. In addition, the first side plate 31 has a distance from the second side plate 32 gradually decreasing from the parts respectively corresponding to the starting end portion and the terminal end portion of the spiral ventilation passage 36 to the part corresponding to the predetermined position P between the starting end portion and the terminal end portion.

The discharge ventilation passage 37 is provided between the first side plate 31 and the second side plate 32, and also between the part of the straight portion 33b on the discharge ventilation passage 35 side and the extension portion 33d. As illustrated in FIG. 3, the dimension of the discharge ventilation passage 37 in the radial direction gradually increases from the terminal end portion of the spiral ventilation passage 36 to the discharge opening 35. In addition, the discharge ventilation passage 37 is separated from the starting end portion of the spiral ventilation passage 36 by the tongue portion 33c.

The connecting ventilation passage 38 is provided between the first side plate 31 and the second side plate 32, and also between the outer periphery of the impeller 10 and the terminal end side of the spiral ventilation passage 36. The section of the first side plate 31 corresponding to the connecting ventilation passage 38 is on approximately the same level as the starting end side and the terminal end side of the spiral ventilation passage 36. The section of the first side plate 31 corresponding to the connecting ventilation passage 38 is coplanar with the starting end side of the spiral ventilation passage 36, and is connected to the terminal end portion of the spiral ventilation passage 36 at the same height without forming a step.

With the fan 1 having the above-described configuration, when the electric motor 20 is driven to rotate the impeller 10 in one circumferential direction, the air outside the casing 30 is sucked into the casing 30 via the suction port 34 formed in the second side plate 32. The air sucked into the casing 30 via the suction port 34 flows into the impeller 10 from the second end side of the axial direction of the impeller 10 and flows radially out of the outer periphery of the impeller 10. The air flowed radially out of the outer periphery of the impeller 10 flows through the spiral ventilation passage 36 and the discharge ventilation passage 37, and then is discharged from the discharge opening 35. Meanwhile, part of the air flows from the terminal end side of the spiral ventilation passage 36 into the starting end side of the spiral ventilation passage 36 via the connecting ventilation passage 38 as a circulating flow.

In this case, the parts of the first side plate 31 respectively corresponding to the starting end portion and the terminal end portion of the spiral ventilation passage 36, and the section of the first side plate 31 corresponding to the connecting ventilation passage 38 are coplanar with each other without forming a step. Therefore, the circulating flow flowing from the terminal end side to the starting end side of the spiral ventilation passage 36 via the connecting ventilation passage 38 can circulate along the first side plate 31 without separating from the first side plate 31. Accordingly, it is possible to prevent the turbulence of the air flow in the starting end side of the spiral ventilation passage 36.

In addition, the dimension H of the spiral ventilation passage 36 in the direction of the rotation axis of the impeller 10 decreases gradually from the starting end side and the terminal end side of the spiral ventilation passage 36 toward the predetermined position P between the starting end portion and the terminal end portion. Moreover, the dimension of the spiral ventilation passage 36 in the radial direction of the impeller 10 gradually increases in the rotating direction of the impeller 10. In this way, the dimension H of the spiral ventilation passage 36 gradually decreases to the predetermined position P, while the dimension of the spiral ventilation passage 36 gradually increases in the radial direction. Therefore, it is possible to prevent an increase in the flow velocity of the circulating flow flowing along the first side plate 31 and into the starting end side of the spiral ventilation passage 36. In addition, the dimension H of the spiral ventilation passage 36 gradually increases from the predetermined position P toward the terminal end side of the spiral ventilation passage 36 while the dimension of the spiral ventilation passage 36 in the radial direction gradually increases. Therefore, it is possible to gradually decrease the flow velocity of the circulating flow flowing to the predetermined position P of the spiral ventilation passage 36 along the first side plate 31 to condition the flow, and consequently to prevent the turbulence of the air flow.

As described above, the fan 1 according to the embodiment has the configuration where a section of the first side plate 31 including the parts respectively corresponding to the starting end side and the terminal end side of the spiral ventilation passage 36 and the part corresponding to the connecting ventilation passage 38 which extends from the terminal end portion of the spiral ventilation passage 36 in the rotating direction of the impeller 10 and is connected to the starting end portion of the spiral ventilation passage 36 is formed by connecting inclined planes having a height gradually changed. The dimension H of the spiral ventilation passage 36 in the direction of the rotation axis of the impeller 10 gradually decreases from the starting end portion and the terminal end portion of the spiral ventilation passage 36 to the predetermined position P between the starting end portion and the terminal end portion of the spiral ventilation passage 36.

By this means, the circulating air having flowed along the first side plate 31 and entered the starting end side from the terminal end side of the spiral ventilation passage 36 via the connecting ventilation passage 38 can be flowed along the first side plate 31 without separating the circulating air from the first side plate 31. In this way, the circulating air having flowed along the first side plate 31 and entered the starting end side of the spiral ventilation passage 36 can be flowed along the first side plate 31, and therefore can be conditioned. As a result, it is possible to prevent noise from being generated to improve the silence.

In addition, the spiral ventilation passage 36 is formed between the flat second side plate 32 and the first side plate 31 having a shape where a distance from the second side plate 32 is gradually changed.

Therefore, the second side plate 32 is formed in a simple shape, and consequently it is possible to reduce the production cost.

The predetermined position P between the starting end side and the terminal end side of the spiral ventilation passage 36 is located at an angle of 180 degrees about the rotation axis of the impeller 10, from the starting end portion to the terminal end portion of the spiral ventilation passage 36.

By this means, it is possible to ensure that the circulating flow having flowed along the first side plate 31 and entered the stating end side of the spiral ventilation passage 36 flows along the first side plate 31.

Here, the above-described embodiment may be applicable to an air conditioner used in buildings or a fan device such as a ventilator, as well as a fan device for a vehicle air conditioner.

In addition, with the above-described embodiment, the spiral ventilation passage 36 and the connecting ventilation passage 38 are formed between the second side plate 32 formed in a flat shape and the first side plate 31 having a shape where a distance from the second side plate 32 is gradually changed. However, this is by no means limiting. For example, the spiral ventilation passage 36 and the connecting ventilation passage 38 may be formed between the first side plate formed in a flat shape and the second side plate having a shape where a distance from the first side plate is gradually changed. Alternatively, the spiral ventilation passage and the connecting ventilation passage may be formed between the first side plate and the second side plate each of which has a height gradually changed in the rotation axis direction of the impeller.

Moreover, with the above-described embodiment, the section of the first side plate 31 corresponding to the connecting ventilation passage 38 is coplanar with the starting end side of the spiral ventilation passage 36, and is connected to the terminal end portion of the spiral ventilation passage 36 at the same height. However, this is by no means limiting as long as the parts of the first side plate 31 respectively corresponding to the starting end side and the terminal end side of the spiral ventilation passage 36 and the section of the first side plate 31 corresponding to the connecting ventilation passage 38 are connected to make a smooth surface without forming a step. In this case, a smooth surface may be formed by connected flat planes having the same height, connected inclined planes having a height gradually changed, or a combination of a flat plane and an inclined plane.

### REFERENCE SIGNS LIST

1 fan, 10 impeller, 30 casing, 31 first side plate, 32 second side plate, 33 outer plate, 34 suction port, 36 spiral ventilation passage, 38 connecting ventilation passage

1. A fan comprising:
a cylindrical impeller; and
a casing configured to accommodate the impeller, and including a spiral ventilation passage formed radially outside the impeller,
the casing including:
a first side plate provided on a first end side of a rotation axis direction of the impeller;
a second side plate provided on a second end side of the rotation axis direction of the impeller, and including an air suction port; and
an outer plate provided radially outside the impeller, wherein:
in each of the first side plate and the second side plate, parts respectively corresponding to a starting end side and a terminal end side of the spiral ventilation passage, and a section corresponding to a connecting ventilation passage which extends from a terminal end portion of the spiral ventilation passage in a rotating direction of the impeller and is connected to a starting end portion of the spiral ventilation passage form a smooth surface by at least one of: connecting flat planes having a certain height; connecting inclined planes having a height gradually changed; or connecting a flat plane and an inclined plane; and
a dimension of the spiral ventilation passage in the rotation axis direction of the impeller gradually decreases from the starting end portion and the terminal end portion of the spiral ventilation passage to a predetermined position between the starting end portion and the terminal end portion of the spiral ventilation passage.

2. The fan according to claim 1, wherein the spiral ventilation passage is formed between the second side plate in a flat shape and the first side plate having a shape where a distance from the second side plate is gradually changed.

3. The fan according to claim 1, wherein the predetermined position between the starting end side and the terminal end side of the spiral ventilation passage has an angle of 180 degrees about the rotation axis of the impeller, from the starting end portion toward the terminal end portion of the spiral ventilation passage.

4. The fan according to claim 2, wherein the predetermined position between the starting end side and the terminal end side of the spiral ventilation passage has an angle of 180 degrees about the rotation axis of the impeller, from the starting end portion toward the terminal end portion of the spiral ventilation passage.
